(19) United States
(12) Patent Application Publication
(10) Pub. No.: US 2026/0080294 A1
(43) Pub. Date: Mar. 19, 2026

(54) System and method for quantum-based Application Programming Interface (API) failure handling and virtualization

(71) Applicant: Bank of America Corporation, Charlotte, NC (US)

(72) Inventors: Partha Sarathi Dhar, Chester Springs, PA (US); Ravi Kiran Hukmani, Telangana (IN); Yogeshkumar Sukumar, Garnet Valley, PA (US); Purvaj P. Motiwala, Wilmington, DE (US); Edward G. Connell, West Grove, PA (US); Hirenkumar R. Patel, Newark, DE (US); Venugopal Ramini, Telangana (IN); VamsiKrishna Are, Telangana (IN); Swarn Deep, New Delhi (IN); Kamal Joshi, Uttar Pradesh (IN); Kanaka Subramaniam Kunjithapatham, Newark, DE (US)

(21) Appl. No.: 18/889,486

(22) Filed: Sep. 19, 2024

(51) Int. Cl. G06N 10/70

(52) U.S. Cl. CPC G06N 10/70

(57) ABSTRACT

A system for implementing a quantum-based application programming interface (API) failure detection and virtualization is disclosed. The system receives an API data packet and converts the API data packet into a set of quantum state arrays. The system generates a unified buffer array that is associated with the corresponding tasks from among the API data packets. The system validates that the unified buffer array corresponds to a quantum representation of the API data packet by comparing the unified buffer array with a vector that comprises binary bits associated with the API data packet and determining that the unified buffer array corresponds to the vector.

### TECHNICAL FIELD

The present disclosure relates generally to network security, and more specifically to a system and method for quantum-based Application Programming Interface (API) failure handling and virtualization.

### BACKGROUND

Computing devices use application programming interface (API) calls to communicate with other devices. Each API call may include a sequence of tasks that are to be performed in sequence, so the API request is performed.

### SUMMARY

The disclosed system, described in the present disclosure, is particularly integrated into a practical application of improving the application programming interface (API) request failure detection and mitigation techniques. This practical application provides several technical advantages, including conserving computational and network resources that would otherwise be used to process and communicate erroneous tasks associated with the API request.

In the current systems, computing devices may use API calls to communicate with other devices. Each API call may include a sequence of tasks that are to be performed in sequence, so the API request is performed. The sequence of tasks is static and any change, such as adding a sub-task or creating another one or more tasks, leads to revising the static task sequence. This, in turn, leads to delays in executing the API call, and handling and debugging failed API calls.

Further, each API call flow may include separate flows in case of a successful API call and a failed API call. In case of a failed API call, the flow may include more tasks to be performed in a sequence. For example, in case of an API call to connect an incoming call to an agent, the API call failure flow may include the sequence of tasks: insert failure data, wait for a threshold duration (e.g., one minute), retry the API call, if retry failed after a certain threshold number of retires (e.g., after the fifth retry), insert retry failure data. Thus, the API call handling and troubleshooting problem is more pronounced in case of API call failures.

The disclosed system is configured to provide a solution to these and other problems in the realm of API failure handling. In some embodiments, the disclosed system is configured to implement a quantum-based API failure handling by converting the API data packet (from binary format) into respective quantum state arrays. For example, in this process, the disclosed system may map each binary bit 0 to a quantum bit |0> and each binary bit 1 to a quantum bit |1>. Thus, in some embodiments, the disclosed system may generate a quantum virtualization or quantum representation of the API data packet flow, for example, in case of an API failure, a quantum virtualization of the API failure handling flow.

The disclosed system may simulate the API failure instance with the quantum virtualization. The disclosed system may validate the generated quantum representation of the API flow by comparing a unified buffer array that represents the quantum representation of the API flow with a vector that represents the API flow in a binary format. In this process, the disclosed system may perform inverse matrix multiplication between the unified buffer array and the binary vector, convolution operation, among others. If it is determined that the unified buffer array corresponds to the binary vector, the disclosed system may determine that the quantum representation of the API flow is valid. Otherwise, the disclosed system may determine that the quantum representation of the API flow is invalid.

In some embodiments, the disclosed system may use the quantum representation of the API flow to process and evaluate the API call flow using quantum computing. For example, in case of an API call failure, the disclosed system may detect and address the failure by detecting the errors that caused the failure and adjusting to one or more tasks to mitigate the errors. In the same or another example, in case of an API call failure, the disclosed system may identify the failed task in the sequence and flag it to be addressed by a network administrator. In this manner, the disclosed system provides technical improvements to API call failure handling and mitigation techniques. Further, the disclosed system is configured to convert an API data packet which is in binary format into quantum bits and simulate the API call flow using the quantum representation of the API data packet. Thus, the disclosed system provides a technical improvement in API data flow simulation and virtualization to evaluate the tasks associated with the API call. Further, by implementing the disclosed system, computational and network resources used to process and handle API failure flows are reduced because the disclosed system allows for parallel processing of the API call and reduces the number of retries in case of a failed API call.

In some embodiments, a system comprises a memory operably coupled with a processor. The memory is configured to store a set of data packets. The processor is configured to receive the set of data packets. The processor is further configured to convert each of the sets of data packets into a respective quantum state array, wherein the respective quantum state array indicates a value of each quantum bit associated with a respective binary bit from among the set of data packets. The processor is further configured to generate a unified buffer array associated with the set of data packets. The processor is further configured to validate that the unified buffer array corresponds to a quantum representation of the set of data packets. In some embodiments, validating that the unified buffer array corresponds to the quantum representation of the set of data packets comprises comparing the unified buffer array with a vector that comprises the set of data packets and determining that the unified buffer array corresponds to the vector based at least in part upon the comparison. Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to implement a quantum-based application programming interface (API) failure detection and virtualization;

FIG. 2 illustrates an example operational flow of the system of FIG. 1; and

FIG. 3 illustrates an example flow chart of a method of the system of FIG. 1.

### DETAILED DESCRIPTION

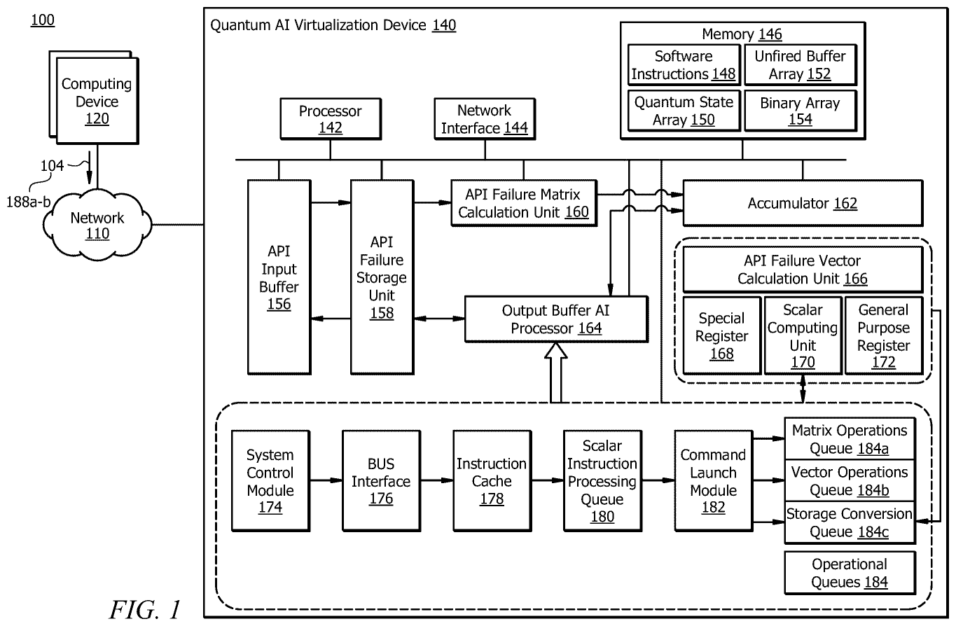

As described above, previous technologies fail to provide efficient and reliable solutions to implement a quantum-based application programming interface (API) failure detection and virtualization. Embodiments of the present disclosure and its advantages may be understood by referring to FIGS. 1 through 3. FIGS. 1 through 3 are used to describe systems and methods for implementing a quantum-based API failure detection and virtualization, according to some embodiments.

### System Overview

FIG. 1 illustrates an embodiment of a system 100 that is generally configured to implement a quantum-based API failure detection and virtualization. In some embodiments, the system 100 comprises a quantum artificial intelligence (AI) virtualization device 140 also referred to herein as a virtualization device 140. The virtualization device 140 is communicatively coupled to computing devices 120 via a network 110. The network 110 enables the communication among the components of the system 100. The computing devices 120 may be used to send data to and receive data from the virtualization device 140. In other embodiments, system 100 may not have all of the components listed and/or may have other elements instead of, or in addition to, those listed above.

In general, the system 100 improves the API failure detection and mitigation techniques. Computing devices 120 may use API calls to communicate with other devices. Each API call may include a sequence of tasks 188a-b that are to be performed in sequence, so the API request is performed. The sequence of tasks 188a-b is static and any change, such as adding a sub-task or creating another one or more tasks leads to revising the static task sequence. This, in turn, leads to delays in executing the API call, and handling and debugging failed API calls.

Further, each API call flow may include separate flows in case of a successful API call and a failed API call. In case of a failed API call, the flow may include more tasks 188a-b to be performed in a sequence. For example, in case of an API call to connect an incoming call to an agent, the API call failure flow may include the sequence of tasks: insert failure data, wait for a threshold duration (e.g., one minute), retry the API call if retry failed for the fifth time, insert retry failure data. Thus, the API call handling and troubleshooting problem is more pronounced in case of API call failures.

The disclosed system 100 is configured to provide a solution to these and other problems in the realm of API failure handling. In some embodiments, the disclosed system 100 is configured to implement a quantum-based API failure handling by converting the API data packet (from binary format) into respective quantum state arrays. For example, in this process, the disclosed system 100 may map each binary bit 0 to a quantum bit |0> and each binary bit 1 to a quantum bit |1>. Thus, in some embodiments, the system 100 may generate a quantum virtualization or quantum representation of the API data packet flow, for example, in case of an API failure, a quantum virtualization of the API failure handling flow.

The system 100 may simulate the API failure instance with the quantum virtualization. The system 100 may validate the generated quantum representation of the API flow by comparing a unified buffer array that represents the quantum representation of the API flow with a vector that represents the API flow in a binary format. In this process, the system 100 may perform inverse matrix multiplication between the unified buffer array and the binary vector, convolution operation, among others. If it is determined that the unified buffer array corresponds to the binary vector, the system 100 may determine that the quantum representation of the API flow is valid. Otherwise, the system 100 may determine that the quantum representation of the API flow is invalid.

In some embodiments, the system 100 may use the quantum representation of the API flow to process and evaluate the API call flow using quantum computing. For example, in case of an API call failure, the system 100 may detect and address the failure by detecting the errors that caused the failure and adjusting to one or more tasks 188a-b to mitigate the errors. In the same or another example, in case of an API call failure, the system 100 may identify the failed task in the sequence and flag it to be addressed by a network administrator. In this manner, the system 100 provides technical improvements to API call failure handling and mitigation techniques. Further, the system 100 is configured to convert an API data packet 104 which is in binary format into quantum bits and simulates the API call flow using the quantum representation of the API data packet 104. Thus, the system 100 provides a technical improvement in API data flow simulation and virtualization to evaluate the tasks 188a-b associated with the API call. Further, by implementing the system 100, computational and network resources used to process and handle API failure flows are reduced because the system 100 allows for parallel processing of the API call and reduces the number of retries in case of the failed API call.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wi-Fi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may include fiber optics, optical fibers, and the like. The network 110 may be configured to support any suitable type of communication protocol as would be appreciated by one of ordinary skills in the art.

### Example Computing Device

Each computing devices 120 may be generally any device that is configured to process data and interact with users. Examples of the computing device 120 include but are not limited to, a personal computer, a desktop computer, a workstation, a server, a laptop, a tablet computer, a mobile phone (such as a smartphone), smart glasses, virtual reality (VR) glasses, a virtual reality device, an augmented reality device, an internet-of-things (IoT) device, or any other suitable type of device. The computing device 120 may include a user interface, such as a display, a microphone, a camera, a keypad, or other appropriate terminal equipment usable by users 102. The computing device 120 may include a hardware processor, memory, and/or circuitry configured to perform any of the functions or actions of the computing device 120 described herein. In the present disclosure, the computing device 120 may be interchangeably referred to as a computing device or a user device.

Each computing device 120 includes a processor in signal communication with a network interface and a memory. The memory stores software instructions that when executed by the processor cause the processor to perform one or more operations of the computing device described herein. The computing device 120 is configured to communicate with other devices and components of the system 100 via the network 110. A user may use a computing device 120 to transmit a data packet 104 (e.g., an API data packet 104) to another device (e.g., virtualization device 140). In some examples, the data packet 104 may include documents, data records, code, and media files (e.g., audio, video, image), among other data that may be transmitted via the network 110. The computing device 120 may be used to initiate a transfer of data packet 104 via the network 110. The data packet 104 may be packaged in a data container for data transmission.

The API data packet 104 may be associated with an API request (e.g., API call) to perform a set of tasks in sequence. Each API call may include a sequence of tasks that are to be performed in sequence so the API request is fulfilled. Each API call flow may include separate flows in case of a successful API call and API call failure. In case of API call failure, the flow may have more tasks to be performed in a sequence. For example, in case of an API call to connect an incoming call to an agent, the API call failure flow may include the tasks: insert failure data, wait for a threshold duration (e.g., one minute), retry the API call, if retry failed for the fifth time, insert retry failure data. In some examples, the API data packet 104 may include data packets associated with different tasks to be performed.

### Quantum Ai Virtualization Device

The quantum AI virtualization device 140 may include one or more hardware computer systems, such as workstations, virtual machines, etc. For example, the virtualization device 140 may be implemented by a plurality of computing devices using distributed computing and/or cloud computing systems in a network. In some embodiments, the virtualization device 140 may be one or more servers in a server farm. In some embodiments, the virtualization device 140 may include one or more servers in one or more data centers, data warehouses, and the like. The virtualization device 140 may be an instance of one or more servers. In certain embodiments, the virtualization device 140 may be configured to provide services and resources (e.g., data and/or hardware resources) to the components of the system 100. The virtualization device 140 may convert each API data packet 104 into respective quantum state arrays 150, generate a unified buffer array 152 based on the quantum state arrays 150, and evaluate the quantum representation/virtualization of the API data packet 104 by comparing the unified buffer array 152 with the array 154 that represents the API data packet 104 in binary format, among other operations described herein.

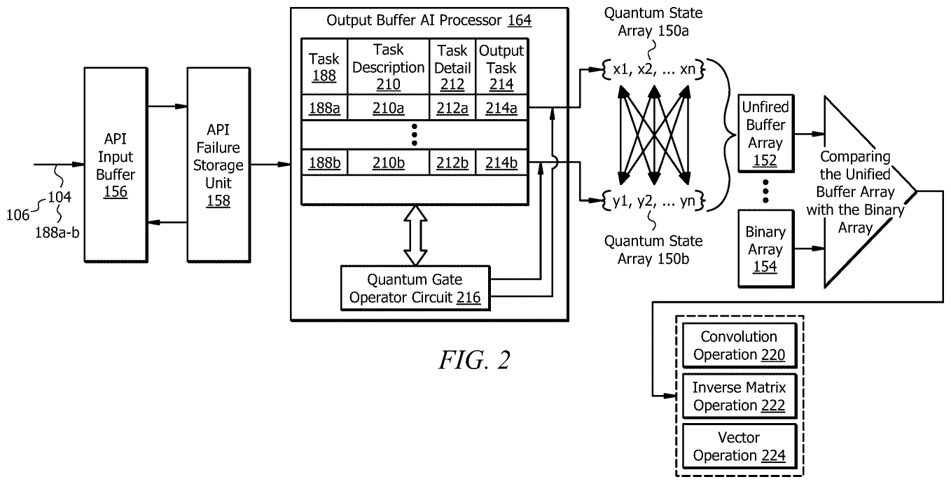

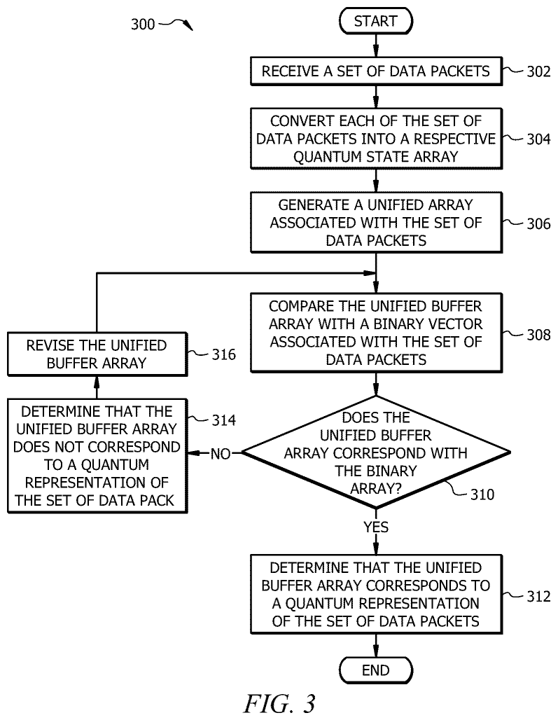

The virtualization device 140 comprises a processor 142 operably coupled with network interface 144, memory 146, API input buffer 156, API failure storage unit 158, API failure matrix calculation unit 160, accumulator 162, output buffer AI processor 164, API failure vector calculation unit 166, special register 168, scalar computing unit 170, general purpose register 172, system control module 174, bus interface 176, instruction cache 178, scalar instruction processing queue 180, command launch module 182, operational queues 184, matrix operations queue 184a, vector operations queue 184b, storage conversion queue 184c, among others. Processor 142 comprises one or more processors. The processor 142 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). For example, one or more processors may be implemented in cloud devices, servers, virtual machines, and the like. The processor 142 may be a programmable logic device, a microcontroller, a microprocessor, or any suitable number and combination of the preceding. The one or more processors are configured to process data and may be implemented in hardware or software. For example, the processor 142 may be 8-bit, 16-bit, 32-bit, 64-bit, or of any other suitable architecture. The processor 142 may include an arithmetic logic unit (ALU) for performing arithmetic and logic operations. The processor 142 may register the supply operands to the ALU and store the results of ALU operations. The processor 142 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the virtualization device 140 described herein. In this way, processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-3. For example, the processor 142 may be configured to perform one or more operations of the operational flow 200 described in FIG. 2, and one or more operations of the method 300 as described in FIG. 3.

Network interface 144 is configured to enable wired and/or wireless communications. The network interface 144 may be configured to communicate data between the virtualization device 140 and other devices, systems, or domains of the system 100. For example, the network interface 144 may comprise a near-field communication (NFC) interface, a Bluetooth interface, a Zigbee interface, a Z-Wave interface, a radio-frequency identification (RFID) interface, a Wi-Fi interface, a local area network (LAN) interface, a wide-area network (WAN) interface, a metropolitan area network (MAN) interface, a personal area network (PAN) interface, a wireless PAN (WPAN) interface, a modem, a switch, and/or a router. The processor 142 may be configured to send and receive data using the network interface 144. The network interface 144 may be configured to use any suitable type of communication protocol.

The memory 146 may be a non-transitory computer-readable medium. The memory 146 may be volatile or non-volatile and may comprise read-only memory (ROM), random-access memory (RAM), ternary content-addressable memory (TCAM), dynamic random-access memory (DRAM), and static random-access memory (SRAM). The memory 146 may include one or more of a local database, cloud database, network-attached storage (NAS), etc. The memory 146 comprises one or more disks, tape drives, or solid-state drives, and may be used as an over-flow data storage device to store programs when such programs are selected for execution, and to store instructions and data that are read during program execution. The memory 146 may store any of the information described in FIGS. 1-3 along with any other data, instructions, logic, rules, or code operable to implement the function(s) described herein when executed by processor 142. For example, the memory 146 may store software instructions 148, quantum state arrays 150, unified buffer arrays 152, binary arrays 154, and/or any other data or instructions. The software instructions 148 may comprise any suitable set of instructions, logic, rules, or code operable to execute the processor 142 and perform the functions described herein, such as some or all of those described in FIGS. 1-3.

The API input buffer 156 may be implemented in a hardware buffer storage structure, such as a register. The API input buffer 156 may be a non-transitory computer-readable medium. The API input buffer 156 may be volatile or non-volatile and may comprise ROM, RAM, TCAM, DRAM, and SRAM. The API input buffer 156 may include one or more of a local database, cloud database, NAS, etc. The API input buffer 156 comprises one or more disks, tape drives, or solid-state drives, and may be used as an over-flow data storage device to store data. The API input buffer 156 may be configured to store incoming API data packets 104 before they are processed. The API failure storage unit 158 may be implemented in a hardware buffer storage structure, such as a register. The API failure storage unit 158 may be a non-transitory computer-readable medium. The API failure storage unit 158 may be volatile or non-volatile and may comprise ROM, RAM, TCAM, DRAM, and SRAM. The API failure storage unit 158 may include one or more of a local database, cloud database, NAS, etc. The API failure storage unit 158 comprises one or more disks, tape drives, or solid-state drives, and may be used as an over-flow data storage device to store data. The API failure storage until 158 may be a dedicated storage unit to store data packets 104 associated with API call failures, such as data packets 104 associated with incomplete tasks 188, tasks 188 associated with an error message or error tag, among others, collectively referred to herein as anomalous tasks 188. The virtualization device 140 may access the data associated with the failed API calls from the API failure storage unit 158 for further processing and troubleshooting, e.g., via conversion into respective quantum state arrays 150.

The API failure matrix calculation unit 160 may be implemented by the processor 142 executing the software instructions 148. The API failure matrix calculation unit 160 may be a computational unit that is configured to determine and process quantum states associated with failed API task 188 by performing matrix operations. For example, the API failure matrix calculation unit 160 may be configured to convert binary formatted API failed tasks 188 (included in the API data packet 104) into a quantum matrix representation where the content of the quantum matrix may be the quantum state arrays 150, vectors, and/or matrix, and bits representing the failed API tasks 188 in vector space and/or Bloch sphere. The Bloch sphere is a geometrical representation of the pure state space of a two-level quantum mechanical system.

The accumulator 162 may be a hardware storage component that is configured to store the results of the matrix and vector calculations performed by the virtualization device 140. The accumulator 162 may be a non-transitory computer-readable medium. The accumulator 162 may be volatile or non-volatile and may comprise ROM, RAM, TCAM, DRAM, and SRAM. The accumulator 162 may include one or more of a local database, cloud database, NAS, etc. The accumulator 162 comprises one or more disks, tape drives, or solid-state drives, and may be used as an overflow data storage device to store data.

The output buffer AI processor 164 is any electronic circuitry, including, but not limited to, state machines, one or more CPU chips, logic units, cores (e.g., a multi-core processor), FPGAs, ASICs, or DSPs. For example, one or more processors may be implemented in cloud devices, servers, virtual machines, and the like. The output buffer AI processor 164 may be a programmable logic device, a microcontroller, a microprocessor, or any suitable number and combination of the preceding. The one or more processors are configured to process data and may be implemented in hardware or software. For example, the output buffer AI processor 164 may be 8-bit, 16-bit, 32-bit, 64-bit, or of any other suitable architecture. The output buffer AI processor 164 may include an ALU for performing arithmetic and logic operations. The output buffer AI processor 164 may register the supply operands to the ALU and store the results of ALU operations. The output buffer AI processor 164 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the virtualization device 140 described herein. In this way, output buffer AI processor 164 may be a special-purpose computer designed to implement the functions disclosed herein. In an embodiment, the output buffer AI processor 164 is implemented using logic units, FPGAs, ASICs, DSPs, or any other suitable hardware. The output buffer AI processor 164 is configured to operate as described in FIGS. 1-3.

The output buffer AI processor 164 may be a processing unit, such as an instance of the processor 142, and configured to process the quantum computations, such as quantum computations related to the failed API tasks 188. The output buffer AI processor 164 may be configured to perform some or all of the quantum computations in conjunction with one or more other components. The output buffer AI processor 164 may determine the output of the quantum computations and store them for further processing, such as validating whether the quantum representation of the API data packet 104 is valid, according to some embodiments described herein.

The API failure vector calculation unit 166 is any electronic circuitry, including, but not limited to, state machines, one or more CPU chips, logic units, cores (e.g., a multi-core processor), FPGAs, ASICs, or DSPs. For example, one or more processors may be implemented in cloud devices, servers, virtual machines, and the like. The API failure vector calculation unit 166 may be a programmable logic device, a microcontroller, a microprocessor, or any suitable number and combination of the preceding. The one or more processors are configured to process data and may be implemented in hardware or software. For example, the API failure vector calculation unit 166 may be 8-bit, 16-bit, 32-bit, 64-bit, or of any other suitable architecture. The API failure vector calculation unit 166 may include an ALU for performing arithmetic and logic operations. The API failure vector calculation unit 166 may register the supply operands to the ALU and store the results of ALU operations. The API failure vector calculation unit 166 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the virtualization device 140 described herein. In this way, API failure vector calculation unit 166 may be a special-purpose computer designed to implement the functions disclosed herein. In an embodiment, the API failure vector calculation unit 166 is implemented using logic units, FPGAs, ASICs, DSPs, or any other suitable hardware. The API failure vector calculation unit 166 is configured to operate as described in FIGS. 1-3.

The API failure vector calculation unit 166 may be implemented by the processor 142 executing the software instructions 148. The API failure vector calculation unit 166 may be a computational unit that is configured to perform vector operations on quantum state vectors (represented by arrays 150) that are associated with failed API tasks 188. The API failure vector calculation unit 166 may perform vector addition, scalar multiplication, among other operations on the quantum state arrays 150.

The special register 168 may be a non-transitory computer-readable medium. The special register 168 may be volatile or non-volatile and may comprise ROM, RAM, TCAM, DRAM, and SRAM. The special register 168 may include one or more of a local database, cloud database, NAS, etc. The special register 168 comprises one or more disks, tape drives, or solid-state drives, and may be used as an overflow data storage device to store data. The special register 168 may be a physical memory component, such as a dedicated register to store specific data during certain operations, such as scalar operations on the quantum state arrays 150.

The scalar computing unit 170 is any electronic circuitry, including, but not limited to, state machines, one or more CPU chips, logic units, cores (e.g., a multi-core processor), FPGAs, ASICs, or DSPs. For example, one or more processors may be implemented in cloud devices, servers, virtual machines, and the like. The scalar computing unit 170 may be a programmable logic device, a microcontroller, a microprocessor, or any suitable number and combination of the preceding. The one or more processors are configured to process data and may be implemented in hardware or software. For example, the scalar computing unit 170 may be 8-bit, 16-bit, 32-bit, 64-bit, or of any other suitable architecture. The scalar computing unit 170 may include an ALU for performing arithmetic and logic operations. The scalar computing unit 170 may register the supply operands to the ALU and store the results of ALU operations. The scalar computing unit 170 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the virtualization device 140 described herein. In this way, scalar computing unit 170 may be a special-purpose computer designed to implement the functions disclosed herein. In an embodiment, the scalar computing unit 170 is implemented using logic units, FPGAs, ASICs, DSPs, or any other suitable hardware. The scalar computing unit 170 is configured to operate as described in FIGS. 1-3.

The scalar computing unit 170 may be a processing unit, such as an instance of the processor 142 and configured to execute scalar operations on the quantum state arrays 150, among others. The scalar computing unit 170 may process the quantum states of the data packets 104 by performing operations such as addition or subtraction on scalar values. These operations may be performed to determine and refine the quantum state arrays 150.

The general-purpose register 172 may be a memory component configured to store various types of data and instructions during the execution of the quantum computations on the quantum state arrays 150. The general-purpose register 172 may be a non-transitory computer-readable medium. The general-purpose register 172 may be volatile or non-volatile and may comprise ROM, RAM, TCAM, DRAM, and SRAM. The general-purpose register 172 may include one or more of a local database, cloud database, NAS, etc. The general-purpose register 172 comprises one or more disks, tape drives, or solid-state drives, and may be used as an overflow data storage device to store data. The general-purpose register 172 may store general computational data and instructions that are not specific to a particular operation. The system control module 174 may be a processing unit that is configured to coordinate the operations of various components. For example, the system control module 174 may be an instance of the processor 142.

The system control module 174 is any electronic circuitry, including, but not limited to, state machines, one or more CPU chips, logic units, cores (e.g., a multi-core processor), FPGAs, ASICs, or DSPs. For example, one or more processors may be implemented in cloud devices, servers, virtual machines, and the like. The system control module 174 may be a programmable logic device, a microcontroller, a microprocessor, or any suitable number and combination of the preceding. The one or more processors are configured to process data and may be implemented in hardware or software. For example, the system control module 174 may be 8-bit, 16-bit, 32-bit, 64-bit, or of any other suitable architecture. The system control module 174 may include an ALU for performing arithmetic and logic operations. The system control module 174 may register the supply operands to the ALU and store the results of ALU operations. The system control module 174 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the virtualization device 140 described herein. In this way, the system control module 174 may be a special-purpose computer designed to implement the functions disclosed herein. In an embodiment, the system control module 174 is implemented using logic units, FPGAs, ASICs, DSPs, or any other suitable hardware. The system control module 174 is configured to operate as described in FIGS. 1-3.

The system control module 174 is any electronic circuitry, including, but not limited to, state machines, one or more CPU chips, logic units, cores (e.g., a multi-core processor), FPGAs, ASICs, or DSPs. For example, one or more processors may be implemented in cloud devices, servers, virtual machines, and the like. The system control module 174 may be a programmable logic device, a microcontroller, a microprocessor, or any suitable number and combination of the preceding. The one or more processors are configured to process data and may be implemented in hardware or software. For example, the system control module 174 may be 8-bit, 16-bit, 32-bit, 64-bit, or of any other suitable architecture. The system control module 174 may include an ALU for performing arithmetic and logic operations. The system control module 174 may register the supply operands to the ALU and store the results of ALU operations. The system control module 174 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the virtualization device 140 described herein. In this way, the system control module 174 may be a special-purpose computer designed to implement the functions disclosed herein. In an embodiment, the system control module 174 is implemented using logic units, FPGAs, ASICs, DSPs, or any other suitable hardware. The system control module 174 is configured to operate as described in FIGS. 1-3. The system control module 174 may manage the execution of tasks 188 of each component and control the flow of data. For example, the system control module 174 and/or the processor 142 may transmit control signals (via wires and/or wireless communication) to various components to provide instructions to be performed.

The bus interface 176 may be an interface between the output buffer AI processor 164 and other components of the visualization device 140. The bus interface 176 may be configured to facilitate communication between the components of the virtualization device 140 via wires and/or wireless communication. For example, the bus interface 176 may facilitate the communication between the output buffer AI processor 164 with other components of the virtualization device 140.

The instruction cache 178 may be a non-transitory computer-readable medium. The instruction cache 178 may be volatile or non-volatile and may comprise ROM, RAM, TCAM, DRAM, and SRAM. The instruction cache 178 may include one or more of a local database, cloud database, NAS, etc. The instruction cache 178 comprises one or more disks, tape drives, or solid-state drives, and may be used as an over-flow data storage device to store data. The instruction cache 178 may be configured to store frequently accessed instructions for fast retrieval.

The scalar instruction processing queue 180 may be a queue that manages scalar instructions waiting to be processed by the scalar computing unit 170. The scalar instruction processing queue 180 may be a memory storage component, e.g., an instance of the memory 146.

The command launch module 182 is any electronic circuitry, including, but not limited to, state machines, one or more CPU chips, logic units, cores (e.g., a multi-core processor), FPGAs, ASICs, or DSPs. For example, one or more processors may be implemented in cloud devices, servers, virtual machines, and the like. The command launch module 182 may be a programmable logic device, a microcontroller, a microprocessor, or any suitable number and combination of the preceding. The one or more processors are configured to process data and may be implemented in hardware or software. For example, the command launch module 182 may be 8-bit, 16-bit, 32-bit, 64-bit, or of any other suitable architecture. The command launch module 182 may include an ALU for performing arithmetic and logic operations. The command launch module 182 may register the supply operands to the ALU and store the results of ALU operations. The command launch module 182 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the virtualization device 140 described herein. In this way, command launch module 182 may be a special-purpose computer designed to implement the functions disclosed herein. In an embodiment, the command launch module 182 is implemented using logic units, FPGAs, ASICs, DSPs, or any other suitable hardware. The command launch module 182 is configured to operate as described in FIGS. 1-3. The command launch module 182 may be a processing unit, such as an instance of the processor 142, and configured to initiate the execution of various instructions and comments for various components of the virtualization device 140. For example, the command launch module 182 may be configured to trigger the execution of scalar, matrix, and vector calculation instructions on the quantum state arrays 150 and/or binary arrays 154. The command launch module 182 (e.g., and/or processor 142) may communicate command instructions to relative components to perform certain operations as described herein.

The operational queues 184 may include matrix operation queues 184a, vector operation queues 184b, and storage conversion queues 184c. The operational queues 184 may be configured to manage different types of operations, such as matrix operations, vector operations, and storage conversions. The matrix operation queues 184a may include instructions for matrix operations to be performed by the API failure matrix calculation unit 160 and/or other components. The vector operation queue 184b may include instructions for vector calculations to be performed by the API failure vector calculation unit 166. The storage conversion queues 184c may include instructions associated with storage of quantum state array 150, among others.

### Operational Flow for Implementing a Quantum-based Api Failure Detection and Virtualization

FIG. 2 illustrates an example operational flow 200 of the system 100 (see FIG. 1) for implementing a quantum-based API failure detection and virtualization. The operational flow 200 of the system 100 may begin when the virtualization device 140 receives the API data packet 104. For example, the virtualization device 140 may receive the API data packet 104 when an API call 106 is initiated by a computing device 120, where the API call requests a specific service or function from another device. The API data packet 104 may include a set of tasks 188, including tasks 188a-b.

The virtualization device 140 may function as a gateway that intercepts or receives the API data packets 104 before it arrives at a destination device, e.g., another computing device 120. The virtualization device 140 may receive the incoming API data packets 104 via the API input buffer 156. In response to receiving the API data packet 104, the virtualization device 140 may evaluate the API data packet 104 whether it is anomalous, e.g., associated with any error tags or incomplete task. To this end, the virtualization device 140 may separate the data packets 104 associated with anomalous tasks 188 from the API data packets 104 and store them in the API failure storage unit 158.

The virtualization device 140 may identify each task 188a-b and convert each data packet 104 associated with each task 188 into a respective quantum state array 150. In this process, the virtualization device 140 (e.g., via the output buffer AI processor 164) may determine each task 188 and its features including task description 210, task detail 212, and output task 214. The task description 210 may indicate a title of the task 188, the task detail 212 may include text that provides detail about the function of the task 188, and output task 214 may indicate the subsequent task 188 in the sequence of tasks 188 for an API request.

The output buffer AI processor 164 may determine each task 188 and its features by parsing the API data packets 104 and data logs that include this information. For example, the output buffer AI processor 164 may determine the task 188a and its features including task description 210a, task detail 212a, and output task 214a, and determine the task 188b, and its features including task 188 description 210b, task detail 212b, and output task 188214b.

In some embodiments, the virtualization device 140 may determine that the first data packet 104 and the second data packet 104 are associated with a corresponding task 188 in response to determining that the first quantum state array 150a has the corresponding length and position in the vector space and/or Bloch space as the second quantum state array 150b.

### Converting Data Packets Into a Quantum State Array

The virtualization device 140 (e.g., via the output buffer AI processor 164) may convert the bit stream associated with each task 188 from the data packet 104 into a respective quantum state array 150. In this process, in some embodiments, the output buffer AI processor 164 may initiate a quantum bit (qubit) for each binary bit included in the data packet 104. For example, the output buffer AI processor 164 may map each binary bit 0 into a qubit |0> and each binary bit 1 to a qubit |1>. The output buffer AI processor 164 may identify the bit streams that represent each task 188. In the example of FIG. 2, the API data packet 104 may include a first data packet 104 associated with the first task 188a, and a second data packet 104 associated with the second task 188b, among others.

The output buffer AI processor 164 may feed the API data packet 104 to a quantum gate operator circuit 216. The quantum gate operator circuit 216 may include a series of quantum gates configured to determine and configure the quantum states of the qubits within the quantum state arrays 150. The input qubits may be fed to the quantum gates of the quantum gate operator circuit 216 to transform the quantum states of the qubits to reflect the specific operations required by each task 188. The quantum gates may include controlled-not gates, Hadamard gates, etc. The quantum states may be arranged in the form of a state vector and arranged in the quantum state array 150. The output of the quantum gate operator circuit 216 may be the quantum state arrays 150.

The quantum gate operator circuit 216 may convert the first data packet 104 representing task 188a into the quantum state array 150a, and the second data packet 104 representing the task 188b into the quantum state array 150b. In some embodiments, the quantum gate operator circuit 216 may implement additional data to indicate the superposition and entanglement properties of quantum bits in each quantum state array 150. For example, some bits that remain the same under any circumstance may be added with an entanglement property to correlate their quantum state to each other, and bits that correlate with each and may be either 0 or 1, may be added with a superposition property where each qubit may represent 0 and 1 simultaneously.

### Generating a Unified Buffer Array

The virtualization device 140 may generate the unified buffer array 152. The unified buffer array 152 may be associated with and/or be a quantum representation of the respective data packet 104 (e.g., representing the respective task 188). In this process, the virtualization device 140 may aggregate the quantum state arrays 150a-b to create a respective unified buffer array 152. For example, each unified buffer array 152 may include content that is related to two quantum state arrays 150 (e.g., quantum state arrays 150a-b).

The virtualization device 140 may compare each element in the quantum state array 150a with each element in the quantum state array 150b to determine the elements with corresponding positions and lengths in the Bloch sphere and/or vector space. In the example of FIG. 1, the virtualization device 140 may compare each of x1, x2, . . . xn which are the elements of the quantum state array 150a with each of y1, y2. . . yn which are the elements of the quantum state array 15b, where each element is a qubit that represents a specific quantum state within the respective quantum state arrays 150a-b.

The virtualization device 140 may determine elements with corresponding lengths and positions from the quantum state arrays 150a-b. The virtualization device 140 may generate the unified buffer array 152 and populate it with the identified elements with corresponding length and position from the quantum state arrays 150a-b. The length of a qubit may refer to a magnitude of a vector that represents the qubit's state. The position of a qubit may refer to a location of the qubit within the quantum state array and/or within the Bloch sphere.

In some embodiments, the virtualization device 140 may determine which quantum state arrays 150 and/or which qubits in each quantum state array 150 have a corresponding length and position in a vector space and/or Bloch sphere. In response, the virtualization device 140 may determine that the first quantum state array 150a (and/or its elements) has the corresponding length and position in the vector space and/or Bloch sphere as the second quantum state array 150b (and/or its elements) indicating that the first quantum state array 150a carries corresponding qubits as the second quantum state array 150b. In response, the virtualization device 140 may pair the first quantum state array 150a with the second quantum state array 150.

The virtualization device 140 may populate the unified buffer array 152 with the paired first quantum state array 150a and the second quantum state array 150b. The virtualization device 140 may perform similar operations for any pair of quantum state arrays 150 to identify the quantum state arrays 150 that are associated with corresponding tasks 188. Thus, the virtualization device 140 may generate a series of unified buffer arrays 152, where each unified buffer array 152 may represent quantum state arrays 150 that represent the same task 188 as each other.

### Validating the Quantum Representation of the Api Data Packet

The virtualization device 140 may validate the quantum representation of the API data packet 104, represented by the unified buffer arrays 152. In this process, the virtualization device 140 may compare the unified buffer array 152 with the respective binary array 154 that includes the binary bits that represent the API data packet 104 to determine whether the quantum states in the unified buffer array 152 correspond to the original binary data in the binary array 154. The virtualization device 140 may perform a similar comparison operation for each unified buffer array 152 and respective binary array 154 that are associated with the same task 188. For example, the virtualization device 140 may compare features of each quantum bit (e.g., the value, magnitude, angle, orientation, etc.) from the unified buffer array 152 with counterpart features of the respective binary bit from the binary array 154. If it is determined that the features of each quantum bit in the unified buffer array 152 correspond to the counterpart features of the respective bits in the binary array 154, the virtualization device 140 may validate that the unified buffer array 152 corresponds to the quantum representation of the API data packet 104.

In some embodiments, the virtualization device 140 may perform a convolution operation 220 between the unified buffer array 152 and the binary array 154 to determine whether they correspond to each other or if there is any difference between them. If the result of the convolution operation 220 is zero or less than a threshold percentage difference (e.g., less than 1%, 0.5% difference) between the unified buffer array 152 and the binary array 154, the virtualization device 140 may determine that the unified buffer array 152 and the binary array 154 correspond to each other.

In some embodiments, the virtualization device 140 may perform an inverse matrix operation 222 (e.g., inverse matrix multiplication) between the unified buffer array 152 and the binary array 154 to determine whether they correspond to each other or if there is any difference between them. If the result of the inverse matrix operation 222 is an identity unit matrix, the virtualization device 140 may determine that the unified buffer array 152 and the binary array 154 correspond to each other.

In some embodiments, the virtualization device 140 may perform a vector operation 224 between the unified buffer array 152 and the binary array 154 to determine whether they correspond to each other or if there is any difference between them. For example, the vector operation 224 may include calculating a dot product or cross product between the unified buffer array 152 and the binary array 154. If the result of the dot product is one or less than a threshold value (e.g., less than 0.2, 0.1, etc.) or if the result of the cross product is less than a threshold value (e.g., less than 0.2, 0.1, etc.), the virtualization device 140 may determine that the unified buffer array 152 and the binary array 154 correspond to each other. If it is determined that the unified buffer array 152 and the binary array 154 correspond to each other, the virtualization device 140 may determine that the unified buffer array 152 is valid, i.e., accurately represents the quantum representation of the API data packet 104.

In response to validating the quantum representation of the API data packet 104, the virtualization device 140 may detect whether each task 188 has failed by processing and analyzing the unified buffer array 152. In this process, for example, the virtualization device 140 may analyze the unified buffer array 152 to identify any discrepancies or anomalies that indicate a failure in executing the respective task 188. By leveraging quantum computing, the anomaly detection process may be performed and concluded in a shorter time compared to traditional computing.

The virtualization device 140 may perform certain operations to detect and mitigate instances of API failures, such as anomalous tasks 188. In some embodiments, the virtualization device 140 may identify the failed tasks 188 based on the process performed to store the failed tasks 188 in the API failure storage unit 158. Thus, the virtualization device 140 may identify the counterpart quantum representation of the failed tasks 188 (e.g., the quantum state arrays 150). In response, the associated task 188 may be flagged to be retired and/or sent to the administrator for further investigation.

### Method for Implementing a Quantum-based Api Failure Detection and Virtualization

FIG. 3 illustrates an example flowchart of a method 300 for implementing a quantum-based API failure detection and virtualization, according to some embodiments. Modifications, additions, or omissions may be made to method 300. Method 300 may include more, fewer, or other operations. For example, operations may be performed in parallel or in any suitable order. While at times, it is described that the system 100, virtualization device 140, or components of any thereof perform some operations, any suitable system or components of the system may perform one or more operations of the method 300. For example, one or more operations of method 300 may be implemented, at least in part, in the form of software instructions 148 of FIG. 1, stored on a tangible non-transitory machine-readable medium (e.g., memory 146 of FIG. 1) that, when run by one or more processors (e.g., processor 142 of FIG. 1), may cause the one or more processors to perform operations 302-316.

At operation 302, the virtualization device 140 receives a set of data packets 104, similar to that described in FIGS. 1-2.

At operation 304, the virtualization device 140 converts each of the set of data packets 104 into a respective quantum state array 150, similar to that described in FIGS. 1-2.

At operation 306, the virtualization device 140 generates a unified buffer array 152 associated with the set of data packets 104, similar to that described in FIGS. 1-2.

At operation 308, the virtualization device 140 compares the unified buffer array 152 with a binary array 154 associated with the set of data packets 104, similar to that described in FIGS. 1-2. At operation 310, the virtualization device 140 determines whether the unified buffer array 152 corresponds with the binary array 154, similar to that described in FIGS. 1-2.

If it is determined that the unified buffer array 152 corresponds with the binary array 154, the method 300 may proceed to operation 312. Otherwise, the method 300 may proceed to operation 314.

At operation 312, the virtualization device 140 may determine that the unified buffer array 152 corresponds to a quantum representation of the set of data packets 104.

At operation 314, the virtualization device 140 determines that the unified buffer array 152 does not correspond to a quantum representation of the set of data packets 104.

At operation 316, the virtualization device 140 revises the unified buffer array 152. For example, the virtualization device 140 may reprocess the quantum state arrays 150, and adjust the quantum states, qubits values, and other properties based on the feedback that indicates the discrepancy between the unified buffer array 152 and the binary array 154.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a memory configured to store a set of data packets, and a processor, operably coupled to the memory, and configured to:
receive the set of data packets;
convert each of the set of data packets into a respective quantum state array, wherein the respective quantum state array indicates a value of each quantum bit associated with a respective binary bit from among the set of data packets;
generate a unified buffer array associated with the set of data packets; and
validate that the unified buffer array corresponds to a quantum representation of the set of data packets, wherein validating that the unified buffer array corresponds to the quantum representation of the set of data packets comprises:
comparing the unified buffer array with a vector that comprises the set of data packets; and
determining that the unified buffer array corresponds to the vector based at least in part upon the comparison.

2. The system of claim 1, wherein:
the set of data packets is associated with an application programming interface (API) request to perform a set of tasks; and
the set of data packets comprises a first data packet associated with a first task and a second data packet associated with a second task.

3. The system of claim 2, wherein converting each of the set of data packets into the respective quantum state array comprises:
converting the first data packet into a first quantum state array;
converting the second data packet into a second quantum state array; and
initializing a qubit for each binary bit from among the set of data packets, wherein each binary bit 0 is converted into a qubit |0> and each binary bit 1 is converted into a qubit |1>.

4. The system of claim 3, wherein generating a unified buffer array associated with a quantum representation of the set of data packets comprises:
determining which quantum state arrays have a corresponding length and position in a vector space;
determining that the first quantum state array has the corresponding length and position in the vector space as the second quantum state array, indicating that the first quantum state array carries corresponding qubits as the second quantum state array;
pairing the first quantum state array with the second quantum state array in response to determining that the first quantum state array has the corresponding length and position in the vector space as the second quantum state array; and
populating the unified buffer array with the paired first quantum state array and the second quantum state array.

5. The system of claim 4, wherein validating that the unified buffer array corresponds to the quantum representation of the set of data packets is in response to:
performing a convolution operation between the unified buffer array and the vector; and
determining that the convolution operation results in zero or less than a threshold percentage difference between the unified buffer and the vector.

6. The system of claim 4, wherein validating that the unified buffer array corresponds to the quantum representation of the set of data packets is in response to:
performing an inverse matrix multiplication between the unified buffer array and the vector; and
determining that the inverse matrix multiplication results in an identity unit matrix.

7. The system of claim 4, the processor is further configured to determine that the first data packet and the second data packet are associated with a corresponding task in response to determining that the first quantum state array has the corresponding length and position in the vector space as the second quantum state array.

8. A method comprising:
receiving a set of data packets;
converting each of the set of data packets into a respective quantum state array, wherein the respective quantum state array indicates a value of each quantum bit associated with a respective binary bit from among the set of data packets;
generating a unified buffer array associated with the set of data packets; and
validating that the unified buffer array corresponds to a quantum representation of the set of data packets, wherein validating that the unified buffer array corresponds to the quantum representation of the set of data packets comprises:
comparing the unified buffer array with a vector that comprises the set of data packets; and
determining that the unified buffer array corresponds to the vector based at least in part upon the comparison.

9. The method of claim 8, wherein:
the set of data packets is associated with an application programming interface (API) request to perform a set of tasks; and
the set of data packets comprises a first data packet associated with a first task and a second data packet associated with a second task.

10. The method of claim 9, wherein converting each of the set of data packets into the respective quantum state array comprises:
converting the first data packet into a first quantum state array;
converting the second data packet into a second quantum state array; and
initializing a qubit for each binary bit from among the set of data packets, wherein each binary bit 0 is converted into a qubit |0> and each binary bit 1 is converted into a qubit |1>.

11. The method of claim 10, wherein generating a unified buffer array associated with a quantum representation of the set of data packets comprises:
determining which quantum state arrays have a corresponding length and position in a vector space;
determining that the first quantum state array has the corresponding length and position in the vector space as the second quantum state array indicating that the first quantum state array carries corresponding qubits as the second quantum state array;
pairing the first quantum state array with the second quantum state array in response to determining that the first quantum state array has the corresponding length and position in the vector space as the second quantum state array; and
populating the unified buffer array with the paired first quantum state array and the second quantum state array.

12. The method of claim 11, wherein validating that the unified buffer array corresponds to the quantum representation of the set of data packets is in response to:
performing a convolution operation between the unified buffer array and the vector; and
determining that the convolution operation results in zero or less than a threshold percentage difference between the unified buffer and the vector.

13. The method of claim 12, wherein validating that the unified buffer array corresponds to the quantum representation of the set of data packets is in response to:
performing an inverse matrix multiplication between the unified buffer array and the vector; and
determining that the inverse matrix multiplication results in an identity unit matrix.

14. The method of claim 12, further comprising determining that the first data packet and the second data packet are associated with a corresponding task in response to determining that the first quantum state array has the corresponding length and position in the vector space as the second quantum state array.

15. A non-transitory computer-readable medium storing instructions that, when executed by a processor, cause the processor to:
receive a set of data packets;
convert each of the set of data packets into a respective quantum state array, wherein the respective quantum state array indicates a value of each quantum bit associated with a respective binary bit from among the set of data packets;
generate a unified buffer array associated with the set of data packets; and
validate that the unified buffer array corresponds to a quantum representation of the set of data packets, wherein validating that the unified buffer array corresponds to the quantum representation of the set of data packets comprises:
comparing the unified buffer array with a vector that comprises the set of data packets; and
determining that the unified buffer array corresponds to the vector based at least in part upon the comparison.

16. The non-transitory computer-readable medium of claim 15, wherein:
the set of data packets is associated with an application programming interface (API) request to perform a set of tasks; and
the set of data packets comprises a first data packet associated with a first task and a second data packet associated with a second task.

17. The non-transitory computer-readable medium of claim 16, wherein converting each of the set of data packets into the respective quantum state array comprises:
converting the first data packet into a first quantum state array;
converting the second data packet into a second quantum state array; and
initializing a qubit for each binary bit from among the set of data packets, wherein each binary bit 0 is converted into a qubit |0> and each binary bit 1 is converted into a qubit |1>.

18. The non-transitory computer-readable medium of claim 17, wherein generating a unified buffer array associated with a quantum representation of the set of data packets comprises:
determining which quantum state arrays have a corresponding length and position in a vector space;
determining that the first quantum state array has the corresponding length and position in the vector space as the second quantum state array, indicating that the first quantum state array carries corresponding qubits as the second quantum state array;
pairing the first quantum state array with the second quantum state array in response to determining that the first quantum state array has the corresponding length and position in the vector space as the second quantum state array; and
populating the unified buffer array with the paired first quantum state array and the second quantum state array.

19. The non-transitory computer-readable medium of claim 18, wherein validating that the unified buffer array corresponds to the quantum representation of the set of data packets is in response to:
performing a convolution operation between the unified buffer array and the vector; and
determining that the convolution operation results in zero or less than a threshold percentage difference between the unified buffer and the vector.

20. The non-transitory computer-readable medium of claim 18, wherein validating that the unified buffer array corresponds to the quantum representation of the set of data packets is in response to:
performing an inverse matrix multiplication between the unified buffer array and the vector; and
determining that the inverse matrix multiplication results in an identity unit matrix.
